(19) United States
(12) Patent Application Publication
(10) Pub. No.: US 2015/0138461 A1
(43) Pub. Date: May 21, 2015

(54) THREE DIMENSIONAL DISPLAY DEVICE

(71) Applicant: Japan Display Inc., Tokyo (JP)

(72) Inventors: Shinichiro OKA, Tokyo (JP); Osamu ITOU, Tokyo (JP); Takeo KOITO, Tokyo (JP); Yingbao YANG, Tokyo (JP); Tomoyuki TAKAHASHI, Tokyo (JP); Shinichi KOMURA, Tokyo (JP); Hiroki SUGIYAMA, Tokyo (JP); Hideki KANEKO, Tokyo (JP)

(73) Assignee: Japan Display Inc.

(21) Appl. No.: 14/542,873

(22) Filed: Nov. 17, 2014

(30) Foreign Application Priority Data
Nov. 18, 2013 (JP) 2013-238131

(51) Int. Cl. G02F 1/13; G02F 1/1347; G02F 1/1362; G02F 1/1333; G02F 1/1335; G02B 27/00; G02F 1/13363; G02B 27/22; G02F 1/1343

(52) U.S. Cl. CPC G02F 1/1323; G02B 27/2214; G02F 1/1347; G02F 1/1362; G02F 1/134363; G02F 1/133528; G02F 1/133514; G02B 27/0093; G02F 1/13363; G02F 1/133345; G02F 2001/13356
USPC 349/15

(57) ABSTRACT

In a three dimensional display device of a parallax barrier system in which an IPS-mode liquid crystal display panel is used as a liquid crystal display panel for displaying images and a TN-mode liquid crystal panel is used as a parallax barrier panel, alignment axes of a counter substrate and a barrier substrate constituting the parallax barrier panel are set to 45 degrees and 135 degrees, respectively, with respect to a horizontal direction of a screen. This allows an improvement in the viewing angle characteristics of the parallax barrier panel and an improvement in the viewing characteristics of the overall three dimensional display device of the parallax barrier system. Thus, even when the line of sight moves, crosstalk between an image for a right eye and an image for a left eye can be prevented thereby allowing a viewer to recognize excellent three dimensional images.

### CLAIM OF PRIORITY

The present application claims priority from Japanese Patent Application JP 2013-238131 filed on Nov. 18, 2013, the content of which is hereby incorporated by reference into this application.

### BACKGROUND OF THE INVENTION

1. Field of the Invention

The present invention relates to a display device, and more particularly, to a three dimensional display device with a liquid crystal parallax barrier panel.

2. Description of the Related Art

As a method for displaying a three dimensional image without using eyeglasses, a parallax barrier system is known. The parallax barrier system is a method in which an image formed by cutting an image in a field of view from a right eye and an image in a field of view from a left eye vertically into strips and alternately arranging the strip images is placed behind a plate having a plurality of vertical small slits, referred to as a parallax barrier panel, and, when the image is viewed through a parallax barrier, a three dimensional image is displayed.

Japanese Published Unexamined Patent Application No. Hei 3-119889 discloses a constitution of a three dimensional display device which can display both a two-dimensional image and a three dimensional image by forming the parallax barrier panel using liquid crystal.

Japanese Published Unexamined Patent Application No. 2012-37807 discloses a constitution of a three dimensional image display with a TN (Twisted Nematic) liquid crystal panel used as the parallax barrier panel.

Three dimensional image display systems include systems with and without the need for special glasses. In the parallax barrier system, stereoscopic display is performed by dividing an image displayed on a display device into a right-eye region and a left-eye region using a barrier pattern formed on the parallax barrier panel, and no special glasses are required.

The parallax barrier panel with liquid crystal has the advantage of allowing easy switching between a two-dimensional image and a three dimensional image as necessary. That is, when a barrier signal is applied and a barrier pattern is formed, the three dimensional display can be performed, and when no barrier signal is applied to the parallax barrier panel, the two-dimensional display can be performed.

On the other hand, as a phenomenon characteristic of the parallax barrier system, the phenomenon occurs in which when the viewing position is fixed, a normal three dimensional image is visible, while when the line of sight of the viewer moves, image information to be originally recognized by a right eye is recognized by a left eye, leading to halation or glare. This phenomenon is referred to as crosstalk.

While liquid crystal display devices have a problem in viewing angle, an IPS (In Plane Switching) mode liquid crystal display device controls the transmittance by causing liquid crystal molecules to rotate parallel to a substrate and therefore has viewing angle characteristics superior to other types of liquid crystal display devices.

On the other hand, in the case where a TN-mode liquid crystal panel is used as the parallax barrier panel, under the influence of the viewing angle characteristics of the liquid crystal panel, image deterioration such as a change in color or contrast caused by movement of the line of sight becomes a problem. Therefore, in this case, even if the IPS-mode liquid crystal display device is used as the display device, it is affected by the viewing angle characteristics of the TN liquid crystal panel used as the parallax barrier panel.

### SUMMARY OF THE INVENTION

Accordingly, an object of the present invention is to realize a three dimensional display device of a parallax barrier system which allows a viewer to recognize a three dimensional image without causing a substantial deterioration in display quality even when the viewer's line of sight moves.

In order to address the above-mentioned problem, the present invention provides the following concrete measure.

(1) A first aspect of the present invention provides a three dimensional display device of a parallax barrier system in which an IPS (In-Plane Switching) mode liquid crystal display panel and a parallax barrier panel, which is a TN (Twisted Nematic) mode liquid crystal panel, are laminated. The three dimensional display device includes the IPS-mode liquid crystal display panel, the parallax barrier panel, and first to third polarizing plates. The IPS-mode liquid crystal display panel has a TFT substrate formed with pixel electrodes and a color filter substrate. The parallax barrier panel has a barrier substrate formed with barrier electrodes and a counter substrate formed with a counter electrode. The barrier electrodes extend in a first direction and are arranged at a first pitch in a second direction. The parallax barrier panel includes a barrier region and an opening region. The barrier region is formed by applying a voltage to a first number of adjacent barrier electrodes. The opening region is formed by applying no voltage to the first number of adjacent barrier electrodes adjacent to the barrier region. The barrier region and the opening region are formed at a second pitch. The barrier region is positionally changeable by changing the barrier electrodes for applying the voltage. The first polarizing plate is disposed under the TFT substrate. The second polarizing plate is disposed above the color filter substrate. The third polarizing plate is disposed above the barrier substrate.

The counter substrate has an alignment axis forming an angle of 45 degrees, plus or minus 10 degrees, with a horizontal direction of a display screen. The color filter substrate has an alignment axis forming an angle of 45 degrees, plus or minus 10 degrees, with the alignment axis of the counter substrate.

(2) Preferably, the three dimensional display device further includes second barrier electrodes disposed below the barrier electrodes with an insulating film interposed therebetween for filling gaps between the barrier electrodes. The first number of barrier electrodes and the first number of the second barrier electrodes form the barrier region.

(3) Preferably, the three dimensional display device further includes a camera for sensing movement of a human eye. The barrier region is positionally changed by changing the barrier electrodes for applying the voltage in accordance with the movement of the human eye.

(4) Preferably, the three dimensional display device further includes a camera for sensing movement of a human eye. The barrier region is positionally changed by changing the barrier electrodes and the second barrier electrodes for applying the voltage in accordance with the movement of the human eye.

(5) Preferably, the three dimensional display device further includes a λ/2 retardation plate disposed between the second polarizing plate and the counter substrate.

(6) Preferably, the three dimensional display device further includes second barrier electrodes disposed below the barrier electrodes with an insulating film interposed therebetween for filling gaps between the barrier electrodes. The first number of barrier electrodes and the first number of the second barrier electrodes form the barrier region.

(7) Preferably, the three dimensional display device further includes a camera for sensing movement of a human eye. The barrier region is positionally changed by changing the barrier electrodes for applying the voltage in accordance with the movement of the human eye.

(8) Preferably, the three dimensional display device further includes a camera for sensing movement of a human eye. The barrier region is positionally changed by changing the barrier electrodes and the second barrier electrodes for applying the voltage in accordance with the movement of the human eye.

(9) Preferably, the three dimensional display device further includes a fourth polarizing plate disposed between the λ/2 retardation plate and the counter electrode.

(10) Preferably, the three dimensional display device further includes second barrier electrodes disposed below the barrier electrodes with an insulating film interposed therebetween for filling gaps between the barrier electrodes. The first number of barrier electrodes and the first number of the second barrier electrodes form the barrier region.

(11) Preferably, the three dimensional display device further includes a camera for sensing movement of a human eye. The barrier region is positionally changed by changing the barrier electrodes for applying the voltage in accordance with the movement of the human eye.

(12) Preferably, the three dimensional display device further includes a camera for sensing movement of a human eye. The barrier region is positionally changed by changing the barrier electrodes and the second barrier electrodes for applying the voltage in accordance with the movement of the human eye.

(13) A second aspect of the present invention provides a three dimensional display device of a parallax barrier system in which an IPS (In-Plane Switching) mode liquid crystal display panel and a parallax barrier panel, which is a TN (Twisted Nematic) mode liquid crystal panel, are laminated. The three dimensional display device includes the IPS-mode liquid crystal display panel, the parallax barrier panel, and first to third polarizing plates. The IPS-mode liquid crystal display panel has a TFT substrate formed with pixel electrodes and a color filter substrate. The parallax barrier panel has a barrier substrate formed with barrier electrodes and a counter substrate formed with a counter electrode. The barrier electrodes extend in a first direction and are arranged at a first pitch in a second direction. The parallax barrier panel includes a barrier region and an opening region. The barrier region is formed by applying a voltage to a first number of adjacent barrier electrodes.

The opening region is formed by applying no voltage to the first number of adjacent barrier electrodes adjacent to the barrier region. The barrier region and the opening region are formed at a second pitch. The barrier region is positionally changeable by changing the barrier electrodes for applying the voltage. The first polarizing plate is disposed under the TFT substrate. The second polarizing plate is disposed above the color filter substrate. The third polarizing plate is disposed above the barrier substrate. The counter substrate has an alignment axis forming an angle of 45 degrees, plus or minus 10 degrees, with a horizontal direction of a display screen. The color filter substrate has an alignment axis forming an angle of 0 degrees, plus or minus 10 degrees, with the alignment axis of the counter substrate.

(14) Preferably, the three dimensional display device further includes second barrier electrodes disposed below the barrier electrodes with an insulating film interposed therebetween for filling gaps between the barrier electrodes. The first number of barrier electrodes and the first number of the second barrier electrodes form the barrier region.

(15) Preferably, the three dimensional display device further includes a camera for sensing movement of a human eye. The barrier region is positionally changed by changing the barrier electrodes for applying the voltage in accordance with the movement of the human eye.

(16) Preferably, the three dimensional display device further includes a camera for sensing movement of a human eye. The barrier region is positionally changed by changing the barrier electrodes and the second barrier electrodes for applying the voltage in accordance with the movement of the human eye.

According to the present invention, a three dimensional display device of a parallax barrier system allows a viewer to recognize a three dimensional image without causing a substantial deterioration in display quality even when the viewer's line of sight moves.

### BRIEF DESCRIPTION OF THE DRAWINGS

FIG. 1 is a schematic sectional view of a three dimensional display device according to one embodiment of the present invention;

FIG. 2 is a schematic sectional view showing the principle of a parallax barrier system;

FIGS. 3A and 3B are plan views showing examples of a pixel electrode having vertical comb teeth and a pixel electrode having horizontal comb teeth, respectively;

FIGS. 4A and 4B are sectional views showing the operation of a parallax barrier panel;

FIGS. 5A and 5B are schematic views each showing the directions of transmission axes of polarizing plates and the directions of alignment axes of substrates, wherein FIG. 5A shows the case where the pixel electrode has vertical comb teeth and the operation is in an e-mode, and FIG. 5B shows the case where the pixel electrode has vertical comb teeth and the operation is in an o-mode;

FIGS. 6A and 6B are schematic views each showing the directions of the transmission axes of the polarizing plates and the directions of the alignment axes of the substrates, wherein FIG. 6A shows the case where the pixel electrode has horizontal comb teeth and the operation is in the e-mode, and FIG. 6B shows the case where the pixel electrode has horizontal comb teeth and the operation is in the o-mode;

FIGS. 7A and 7B are contour lines representing the contrast distribution, wherein FIG. 7A shows the case where an alignment axis is oriented in a horizontal direction on a TN liquid crystal panel, and FIG. 7B shows the case where an alignment axis is oriented in a direction of 45 degrees with respect to the horizontal direction on the TN liquid crystal panel;

FIG. 8 is a schematic view showing the directions of transmission axes of polarizing plates and the directions of alignment axes of substrates of an IPS-mode liquid crystal display panel and a TN-mode parallax barrier panel according to a first embodiment of the present invention;

FIG. 9 is a table showing the directions of the transmission axes of the polarizing plates and the alignment axes of the substrates for various combinations of the liquid crystal display panel and the parallax barrier panel according to the first embodiment of the present invention;

FIG. 10 is a graph representing the relationship between the alignment axis direction and transmittance of the TN liquid crystal panel;

FIG. 11 is a table showing a comparison of crosstalk in front of a screen and crosstalk in the case of a viewing angle of 30 degrees in the three dimensional display device of the parallax barrier system between the related art and first to fourth embodiments of the present invention;

FIG. 12 is a schematic view showing an eye tracking system;

FIGS. 13A to 13C are schematic sectional views showing the principle of the parallax barrier system according to one embodiment of the present invention, in the case where the line of sight moves;

FIG. 14 is a sectional view showing formation of a barrier region and an opening region on the parallax barrier panel according to one embodiment of the present invention;

FIG. 15 is a sectional view showing formation of a barrier region and an opening region on the parallax barrier panel having two-layer barrier electrodes according to one embodiment of the present invention;

FIG. 16 is a sectional view showing another example of formation of a barrier region and an opening region on the parallax barrier panel having two-layer barrier electrodes according to one embodiment of the present invention;

FIG. 17 is a schematic view showing the directions of transmission axes of polarizing plates and the directions of alignment axes of substrates of an IPS-mode liquid crystal display panel and a TN-mode parallax barrier panel according to a second embodiment of the present invention;

FIG. 18 is a table showing the directions of transmission axes of polarizing plates and alignment axes of substrates for various combinations of the liquid crystal display panel and the parallax barrier panel according to the second embodiment of the present invention;

FIG. 19 is a schematic view showing the directions of transmission axes of polarizing plates and the directions of alignment axes of substrates of an IPS-mode liquid crystal display panel and a TN-mode parallax barrier panel according to a third embodiment of the present invention;

FIG. 20 is a table showing the directions of transmission axes of polarizing plates and alignment axes of substrates for various combinations of the liquid crystal display panel and the parallax barrier panel according to the third embodiment of the present invention;

FIG. 21 is a schematic view showing the directions of transmission axes of polarizing plates and the directions of alignment axes of substrates of an IPS-mode liquid crystal display panel and a TN-mode parallax barrier panel according to a fourth embodiment of the present invention; and

FIG. 22 is a table showing the directions of transmission axes of polarizing plates and alignment axes of substrates for various combinations of the liquid crystal display panel and the parallax barrier panel according to the fourth embodiment of the present invention.

### DESCRIPTION OF THE PREFERRED EMBODIMENTS

Hereinafter, embodiments of the present invention will be described in detail.

### First Embodiment

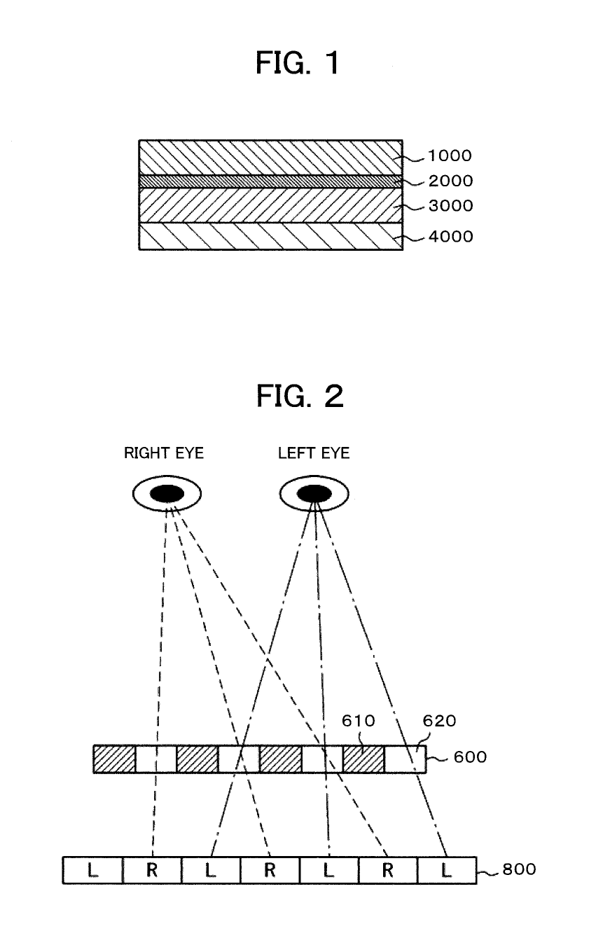

FIG. 1 is a schematic sectional view of a three dimensional display device according to one embodiment of the present invention. The device shown in FIG. 1 is configured to allow a viewer to visually recognize an image formed by a liquid crystal display panel 3000 as a three dimensional image using a liquid crystal parallax barrier panel 1000. The liquid crystal parallax barrier panel (hereinafter referred to as the parallax barrier panel) 1000 and the liquid crystal display panel 3000 are bonded together by a transparent adhesive member 2000.

Since the liquid crystal display device does not emit light by itself, a backlight 4000 is disposed on the back of the liquid crystal display panel 3000. The backlight 4000 includes a light source and other optical components, such as a light guide plate, a diffusion sheet, and optionally, a prism sheet for improving the utilization efficiency of light.

FIG. 2 is a sectional view showing the principle of three dimensional image display of a parallax barrier system. A barrier region 610 and an opening region 620 formed on a barrier pattern 600 cause a right eye to recognize only an image for a right eye formed on a display device 800 and a left eye to recognize only an image for a left eye, thereby allowing a human to recognize a three dimensional image.

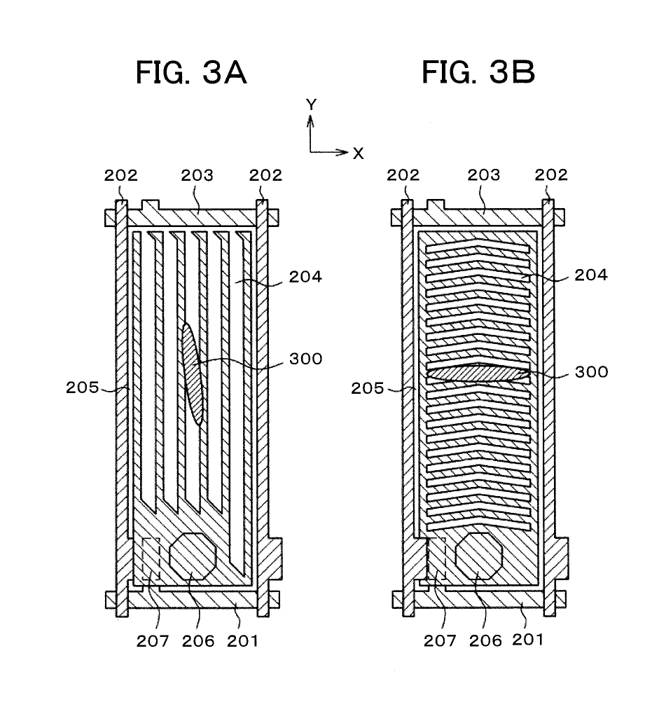

In this embodiment, an IPS-mode liquid crystal display panel is used as the display device 800. The IPS-mode liquid crystal display panel has the advantage of preventing deterioration in the display quality of an image even when the viewing angle of a screen is increased. FIGS. 3A and 3B are plan views showing representative pixel structures of the IPS-mode liquid crystal display panel. In FIGS. 3A and 3B, a pixel is formed in a region surrounded by a video signal line 202 and a scan line 201.

Referring to FIG. 3A, a pixel electrode 203 having vertical slits 204 is formed, and a common electrode 205 is formed in a planar shape through an interlayer insulating film (not shown) below the pixel electrode 203. Video signals are supplied to the pixel electrode 203 through a TFT 207 and a through-hole 206 connected to a source electrode of the TFT 207 from the video signal line 202. Switching of the TFT 207 is performed by a gate electrode branched from the scan line 201.

In FIG. 3A, when a voltage is supplied to the pixel electrode 203 from the video signal line 202, a line of electric force is generated between the pixel electrode 203 and the common electrode 205. The line of electric force reaches the common electrode 205 formed below the pixel electrode 203 through the slits 204 formed in the pixel electrode 203 or an end of the pixel electrode 203 after passing through a liquid crystal layer once. Liquid crystal molecules 300 in the liquid crystal layer are rotated by a lateral electric field component of the line of electric force from the pixel electrode 203, that is, an electric field component parallel to a principal surface of a substrate. The IPS-mode liquid crystal display device forms an image by controlling, for each pixel, the amount of light from the backlight 4000 to pass through the pixel, on the basis of the amount of rotation of the liquid crystal molecules 300.

The liquid crystal molecules 300 are subjected to initial alignment by an alignment film formed on the pixel electrode 203, and the light transmittance is controlled on the basis of the amount of rotation from the direction of the initial alignment. Hereinafter, the direction of the initial alignment for the liquid crystal molecules 300 formed on the alignment film is referred to as an alignment axis of the alignment film. The alignment processing for the alignment film may include rubbing or light irradiation with polarized ultraviolet rays. In FIG. 3A, the alignment axis is inclined at about 8 degrees to a longitudinal direction of the slits 204 of the pixel electrode 203, namely the y-direction in FIG. 3A. The inclination of the long axis of the liquid crystal molecules 300 in FIG. 3A indicates the direction of the initial alignment, that is, the alignment axis. This is intended to cause all liquid crystal molecules in the pixel to rotate in the same direction when the liquid crystal molecules 300 are subjected to a lateral electric field. The configuration being such that all liquid crystal molecules in the pixel are rotated in the same direction is referred to as a single domain. Hereinafter, the pixel structure shown in FIG. 3A is referred to as vertical comb teeth.

FIG. 3B has the same basic principle of the IPS-mode operation as FIG. 3A. FIG. 3B differs from FIG. 3A in the shape of the pixel electrode 203 and the direction of the alignment axis for the liquid crystal molecules 300 formed on the alignment film. Referring to FIG. 3B, the slits 204 formed in the pixel electrode 203 are aligned horizontally and bent in the central portion. Furthermore, the alignment axis of the alignment film in FIG. 3B is parallel to the direction of the scan line 201, namely the x-direction in FIG. 3B. In FIG. 3B, the long axis direction of the liquid crystal molecules 300 corresponds to the direction of the initial alignment. It should be noted that although in FIGS. 3A and 3B, the liquid crystal molecules 300 are shown in enlarged dimension to facilitate the understanding of the direction of the initial alignment, their actual size is too small to be visible.

In the pixel structure shown in FIG. 3B, the inclination of the slits 204 in the pixel electrode 203 with respect to the alignment axis set horizontal is different between right and left sides of the pixel. Therefore, when a voltage is applied to the pixel electrode 203, the liquid crystal molecules 300 on the right and left sides of the pixel rotate in opposite directions. Thus, the viewing angle characteristics of the liquid crystal display panel can be made more uniform. As described above, the case where there are multiple rotational directions of the liquid crystal molecules 300 in the pixel is referred to as a multi-domain. Although the multi-domain allows an improvement in viewing angle characteristics, a region not allowing light to pass therethrough in a domain boundary is generated, so that the pixel transmittance is lowered by this amount. In FIG. 3B, the vicinity of a vertical center line of the pixel which connects bent portions of the slits 204 corresponds to this boundary. Hereinafter, the pixel electrode structure shown in FIG. 3B is referred to as horizontal comb teeth.

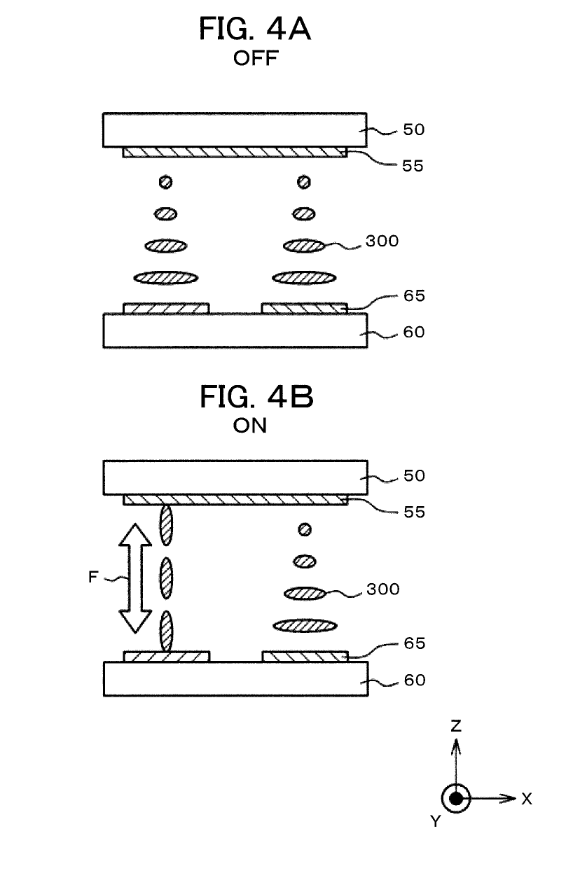

FIGS. 4A and 4B are sectional views showing the principle of the operation of the liquid crystal parallax barrier panel. Both FIGS. 4A and 4B are a TN (Twisted Nematic) mode liquid crystal panel. Referring to FIG. 4A, a counter electrode 55 is formed flat on a counter substrate 50, and stripe-like barrier electrodes 65 extend vertically on the drawing sheet with predetermined spaced pitches on a barrier substrate 60. FIG. 4A shows the state in which no voltage is applied between the counter electrode 55 and the barrier electrode 65, and the light from the liquid crystal display panel undergoes no modulation. In this case, therefore, a two-dimensional image is displayed.

FIG. 4B shows the case where a voltage is alternately applied to the barrier electrodes 65 of the same parallax barrier panel. The region corresponding to the barrier electrodes 65 with a voltage applied is shielded from light, and the region corresponding to the barrier electrodes 65 with a voltage not applied allows light to pass therethrough. Thus, the stripe-like light shielding regions and the stripe-like opening regions are alternately formed when seen from the principal surface of the parallax barrier panel.

In this embodiment, the TN-mode liquid crystal panel is used as the parallax barrier panel, and the IPS-mode liquid crystal display panel is used as the display device. The directions of the alignment axes of the liquid crystal display panel and the directions of transmission axes of polarizing plates attached to the liquid crystal display panel vary depending on whether the so-called “e-mode” or “o-mode” is used for the liquid crystal display panel. Also, the directions of the alignment axes of the liquid crystal display panel and the directions of the transmission axes of the polarizing plates attached to the liquid crystal display panel vary depending on whether the pixel electrode has horizontal comb teeth or vertical comb teeth. Therefore, there are four combinations, depending on whether the e-mode or the o-mode is used and depending on whether horizontal comb teeth or vertical comb teeth are used for the pixel electrode 203.

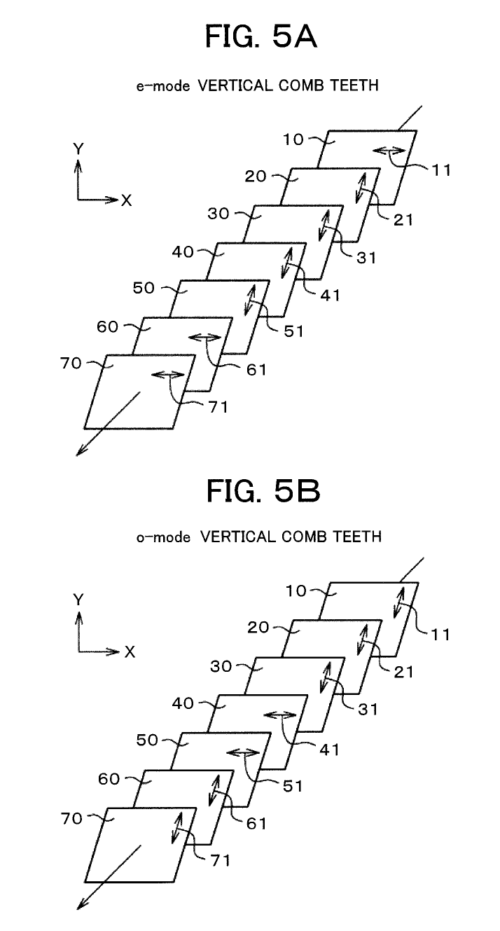

FIGS. 5A and 5B show the case where vertical comb teeth are used for the pixel electrode 203, FIG. 5A showing the e-mode and FIG. 5B showing the o-mode. Referring to FIGS. 5A and 5B, an alignment axis 21 of a TFT substrate 20 and an alignment axis 31 of a color filter substrate 30, which constitute the liquid crystal display panel, are oriented in the same direction, namely the y-direction. Although the alignment axes of the liquid crystal display panel are actually inclined at about 8 degrees to the y-direction, the directions of the alignment axes are referred to as the y-direction in FIGS. 5A and 5B.

Since FIG. 5A shows the e-mode, a transmission axis 11 of a first polarizing plate 10 attached to the lower side of the TFT substrate 20 is oriented in a direction perpendicular to the alignment axis 21 of the TFT substrate 20, namely the x-direction. Furthermore, a transmission axis 41 of a second polarizing plate 40 attached to the upper side of the color filter substrate 30 is oriented in the y-direction the same as the alignment axis 31 of the color filter substrate 30 of the liquid crystal display panel. An alignment axis 51 of the counter substrate 50 constituting the parallax barrier panel is oriented in the y-direction the same as the transmission axis 41 of the second polarizing plate 40, and an alignment axis 61 of the barrier substrate 60 is oriented in the x-direction. This is because the TN-mode liquid crystal display device is used as the parallax barrier panel. A transmission axis 71 of a third polarizing plate 70 attached to the outer side of the barrier substrate 60 is oriented in the x-direction the same as the alignment axis 61 of the barrier substrate 60.

Since FIG. 5B shows the o-mode, the transmission axis 11 of the first polarizing plate 10 attached to the lower side of the TFT substrate 20 is oriented in a direction parallel to the alignment axis 21 of the TFT substrate 20, namely the y-direction. Furthermore, the transmission axis 41 of the second polarizing plate 40 attached to the upper side of the color filter substrate 30 is oriented in the x-direction perpendicular to the alignment axis 31 of the color filter substrate 30 of the liquid crystal display panel. The alignment axis 51 of the counter substrate 50 constituting the parallax barrier panel is oriented in the x-direction the same as the transmission axis 41 of the second polarizing plate 40, and the alignment axis 61 of the barrier substrate 60 is oriented in the y-direction. This is because the TN-mode liquid crystal display device is used as the parallax barrier panel. The transmission axis 71 of the third polarizing plate 70 attached to the outer side of the barrier substrate 60 is oriented in the y-direction the same as the alignment axis 61 of the barrier substrate 60.

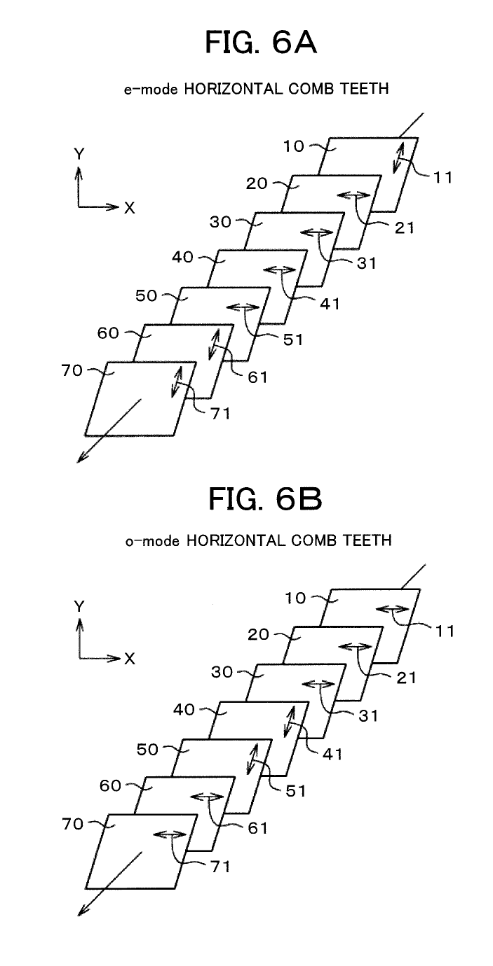

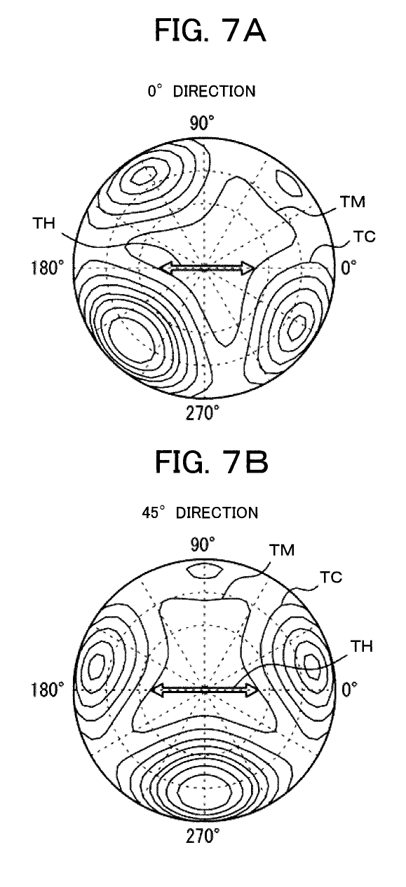

FIGS. 6A and 6B show the case where horizontal comb teeth are used for the pixel electrode 203, FIG. 6A showing the e-mode and FIG. 6B showing the o-mode. Referring to FIGS. 6A and 6B, the alignment axis 21 of the TFT substrate 20 and the alignment axis 31 of the color filter substrate 30, which constitute the liquid crystal display panel, are oriented in the same direction, namely the x-direction.

Since FIG. 6A shows the e-mode, the transmission axis 11 of the first polarizing plate 10 attached to the lower side of the TFT substrate 20 is oriented in a direction perpendicular to the alignment axis 21 of the TFT substrate 20, namely the y-direction. Furthermore, the transmission axis 41 of the second polarizing plate 40 attached to the upper side of the color filter substrate 30 is oriented in the x-direction the same as the alignment axis 31 of the color filter substrate 30 of the liquid crystal display panel. The alignment axis 51 of the counter substrate 50 constituting the parallax barrier panel is oriented in the x-direction the same as the transmission axis 41 of the second polarizing plate 40, and the alignment axis 61 of the barrier substrate 60 is oriented in the y-direction. This is because the TN-mode liquid crystal display device is used as the parallax barrier panel. The transmission axis 71 of the third polarizing plate 70 attached to the outer side of the barrier substrate 60 is oriented in the y-direction the same as the alignment axis 61 of the barrier substrate 60.

Since FIG. 6B shows the o-mode, the transmission axis 11 of the first polarizing plate 10 attached to the lower side of the TFT substrate 20 is oriented in a direction parallel to the alignment axis 21 of the TFT substrate 20, namely the x-direction. Furthermore, the transmission axis 41 of the second polarizing plate 40 attached to the upper side of the color filter substrate 30 is oriented in the y-direction perpendicular to the alignment axis 31 of the color filter substrate 30 of the liquid crystal display panel. The alignment axis 51 of the counter substrate 50 constituting the parallax barrier panel is oriented in the y-direction the same as the transmission axis 41 of the second polarizing plate 40, and the alignment axis 61 of the barrier substrate 60 is oriented in the x-direction. This is because the TN-mode liquid crystal display device is used as the parallax barrier panel. The transmission axis 71 of the third polarizing plate 70 attached to the outer side of the barrier substrate 60 is oriented in the x-direction the same as the alignment axis 61 of the barrier substrate 60.

Meanwhile, the TN-mode liquid crystal display panel has a problem in viewing angle. More specifically, when a screen is viewed in an oblique direction, the contrast of the screen is deteriorated or the chromaticity is changed. Therefore, when the TN-mode liquid crystal panel is used as the parallax barrier panel, the viewing angle becomes a problem. In the TN liquid crystal panel, the rubbing alignment processing method is used for the alignment processing for the alignment film. The TN liquid crystal panel has the widest and symmetric viewing angle in a rubbing direction, namely the direction of 45 degrees with respect to the alignment axis.

In FIGS. 5A and 5B or FIGS. 6A and 6B, the alignment axis 51 or 61 of the counter substrate 50 or the barrier substrate 60 of the TN liquid crystal panel is aligned with the alignment axis 21 or 31 of the TFT substrate 20 or the color filter substrate 30 of the IPS-mode liquid crystal display panel used as the display device. Consequently, the alignment axis direction is the x-direction or the y-direction, and the region where the viewing angle is wide and symmetric is in the direction of 45 degrees with respect to the x-direction or the y-direction.

The contrast distribution in this case is shown in FIG. 7A. In FIG. 7A, the curve lines are contour lines representing the contrast, and the contour line indicated by TM corresponds to a range where the contrast is maximum. Referring to FIG. 7A, a portion TH where the contrast is high in the horizontal direction, i.e., 0°-180° direction, lie within a limited range.

However, liquid crystal display devices of the parallax barrier system have problems when the viewer's line of sight moves in a direction perpendicular to the extending direction of the barrier pattern, namely the x-direction. In this embodiment, therefore, the alignment axes 51 and 61 of the counter substrate 50 and the barrier substrate 60 constituting the parallax barrier panel are oriented in the 45-degree direction with respect to the x-direction, thereby increasing the viewing angle in the direction perpendicular to the extending direction of the barrier pattern, namely the x-direction.

FIG. 7B shows the distribution of the contour lines indicating the viewing angle characteristics of the parallax barrier panel according to this embodiment. In FIG. 7B, the contour line corresponding to a range where the contrast is maximum is indicated by TM. A portion TH where the contrast is high in the 0°-180° direction is increased relative to FIG. 7A. Thus, deterioration in contrast or a change in chromaticity when the viewer's line of sight moves in the parallax barrier system can be reduced.

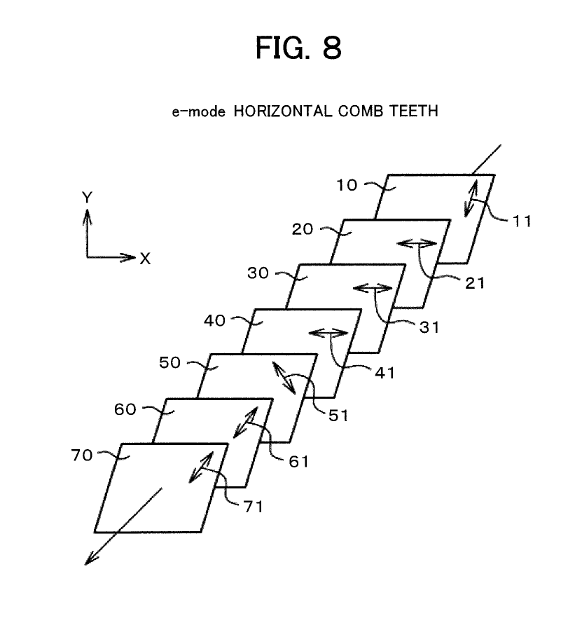

FIG. 8 is a schematic view showing the relationship among the transmission axes 11, 41, and 71 of the first to third polarizing plates 10, 40, and 70, the alignment axes 21 and 31 of the TFT substrate 20 and the color filter substrate 30, and the alignment axes 51 and 61 of the counter substrate 50 and the barrier substrate 60 constituting the parallax barrier panel, in the case where the pixel electrode has horizontal comb teeth and the operation is in the e-mode. The relationship among the transmission axes 11 and 41 of the first and second polarizing plates 10 and 40 and the alignment axes 21 and 31 of the TFT substrate 20 and the color filter substrate 30 varies depending on whether in the e-mode or in the o-mode. The important point in FIG. 8 is that the alignment axis 31 of the color filter substrate 30 or the transmission axis 41 of the second polarizing plate 40 is not aligned with the alignment axis 51 of the counter substrate 50 constituting the parallax barrier panel. In FIG. 8, the alignment axes 51 and 61 of the counter substrate 50 and the barrier substrate 60 constituting the parallax barrier panel are inclined at 45 degrees to the x-direction, thereby allowing an improvement of the horizontal viewing angle of the three dimensional display device of the parallax barrier system. In this case, the above angle does not need to be exactly 45 degrees and, for practical purposes, can be roughly 45 degrees, plus or minus 10 degrees.

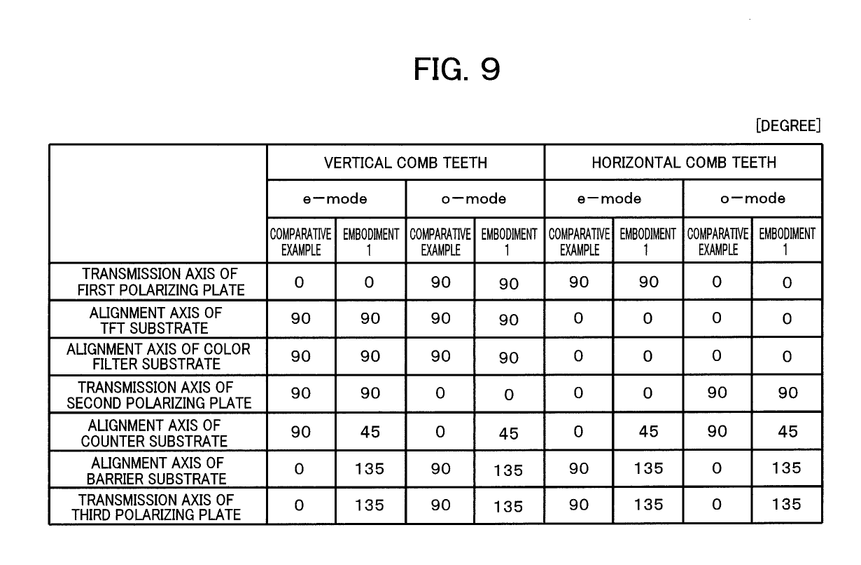

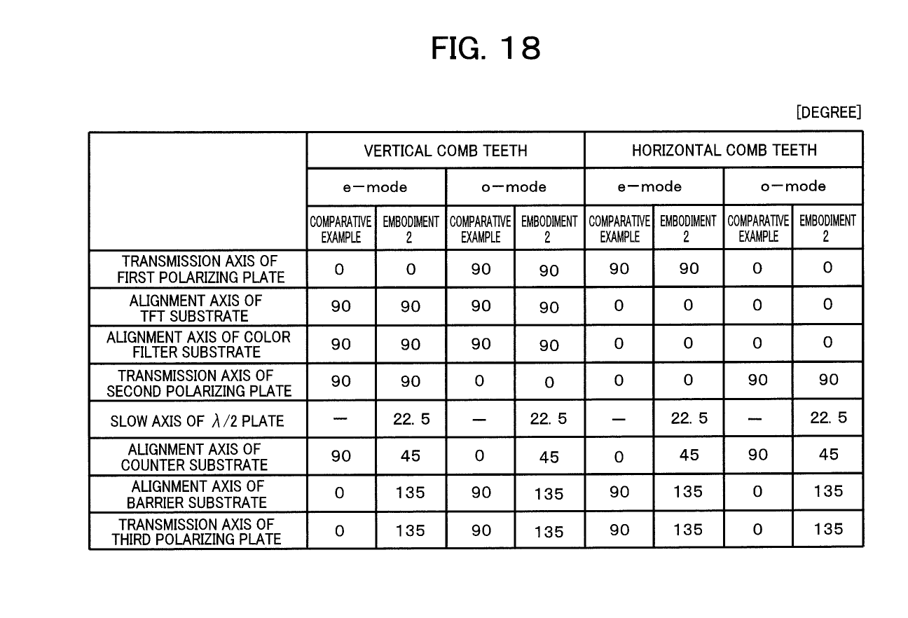

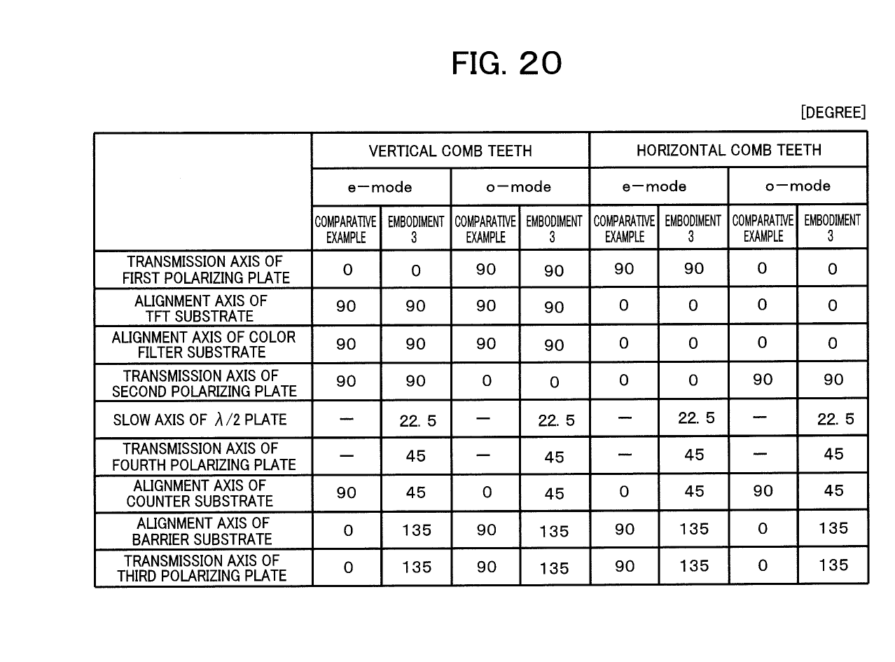

FIG. 9 is a table showing the relationship among the transmission axes 11, 41, and 71 of the first to third polarizing plates 10, 40, and 70, and the alignment axes of the substrates of the crystal liquid display panel and the parallax barrier panel according to the first embodiment. The constitutions described in FIGS. 5A, 5B, 6A, and 6B are shown as comparative examples. The box of the first embodiment is as follows. The first embodiment can be applied to any case where the pixel electrode has vertical comb teeth or horizontal comb teeth, or where the operation is in the e-mode or o-mode. In this embodiment, the transmission axes 11 and 41 of the first and second polarizing plates 10 and 40 and the alignment axes 21 and 31 of the TFT substrate 20 and the color filter substrate 30 are the same as in the comparative examples. The first embodiment differs from the comparative examples in that the alignment axes 51 and 61 of the counter substrate 50 and the barrier substrate 60 of the parallax barrier panel or the transmission axis 71 of the third polarizing plate 70 is 45 or 135 degrees. In FIG. 9, the two angles, 45 and 135 degrees, are interchangeable. The alignment axes 51 and 61 of the counter substrate 50 and the barrier substrate 60 of the parallax barrier panel or the transmission axis 71 of the third polarizing plate 70 only needs to cross at an angle of 45 degrees to the x-direction, whether it be in a plus direction or in a minus direction. The same applies to tables shown in FIGS. 18 and 20. It should be noted that in this case, the angle does not need to be exactly 45 degrees and, for practical purposes, can be roughly 45 degrees, plus or minus 10 degrees.

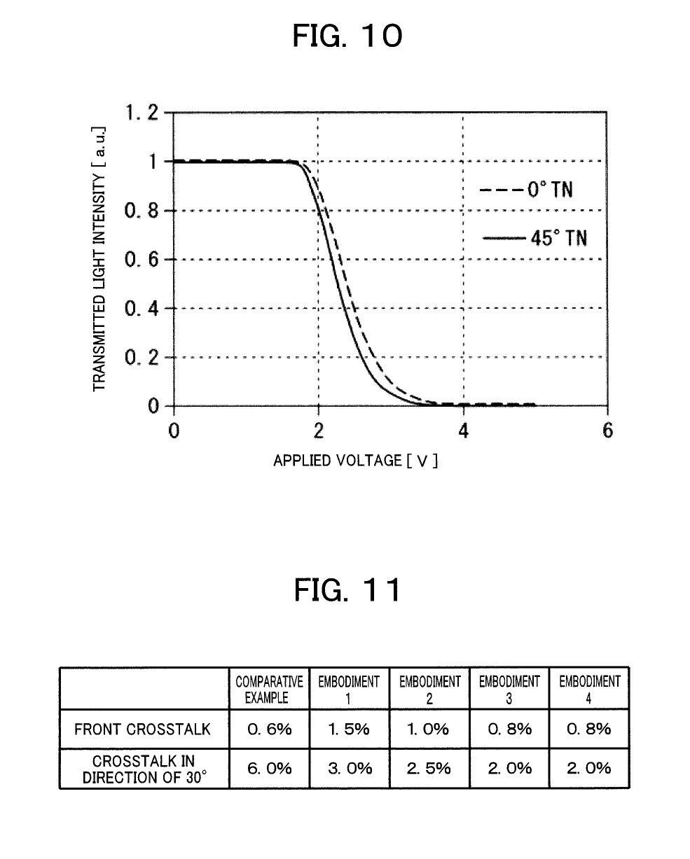

FIG. 10 shows a comparison of the light transmittance between the case where the alignment axes 51 and 61 of the counter substrate 50 and the barrier substrate 60 constituting the parallax barrier panel are aligned with the transmission axis 41 or 71 of the second or third polarizing plate 40 or 70 (set to an angle of 0°) and the case, as in this embodiment, where the alignment axes 51 and 61 of the counter substrate 50 and the barrier substrate 60 constituting the parallax barrier panel is set to an angle of 45 degrees with respect to the transmission axis 41 or 71 of the second or third polarizing plate 40 or 70. In FIG. 10, the abscissa represents voltage between the counter substrate 50 and the barrier substrate 60 and the ordinate represents transmittance of the parallax barrier panel. As shown in FIG. 10, when the alignment axes 51 and 61 of the counter substrate 50 and the barrier substrate 60 constituting the parallax barrier panel are set to an angle of 45 degrees with respect to the transmission axis 41 or 71 of the second or third polarizing plate 40 or 70, there does not appears to be a significant change in the transmittance of the parallax barrier panel as compared with the case where they are set to an angle of 0 degrees. It can be said from this result that there is no influence on optical performance even if the alignment axes 51 and 61 of the counter substrate 50 and the barrier substrate 60 are set to an angle of 45 degrees. FIG. 11 shows a comparison of this influence between the front crosstalk and the crosstalk in the case where the viewing angle is 30 degrees from the normal direction of a screen in the parallax barrier system. FIG. 11 also includes second to fourth embodiments which will be described later. Referring to FIG. 11, in the comparative example, the front crosstalk is 0.6%, while in the first embodiment, it is 1.5% and the display quality is deteriorated. On the other hand, in the comparative example, when the screen is viewed from a direction inclined at 30 degrees with respect to the normal direction, the crosstalk is 6%, while in the first embodiment, it is 3% and the display quality is drastically improved. Therefore, it can be said that in the first embodiment, the overall three dimensional display with the viewing angle taken into consideration is improved as compared with the comparative example.

In this manner, the present invention is aimed chiefly at preventing an increase in crosstalk even when the line of sight moves, by improving the viewing angle of the TN liquid crystal panel used as the parallax barrier panel. By moving the position of the parallax barrier in accordance with the movement of the line of sight, the crosstalk due to the movement of the line of sight can be further reduced. In this case, firstly, it is necessary to detect the movement of the line of sight and feed it back to the display device.

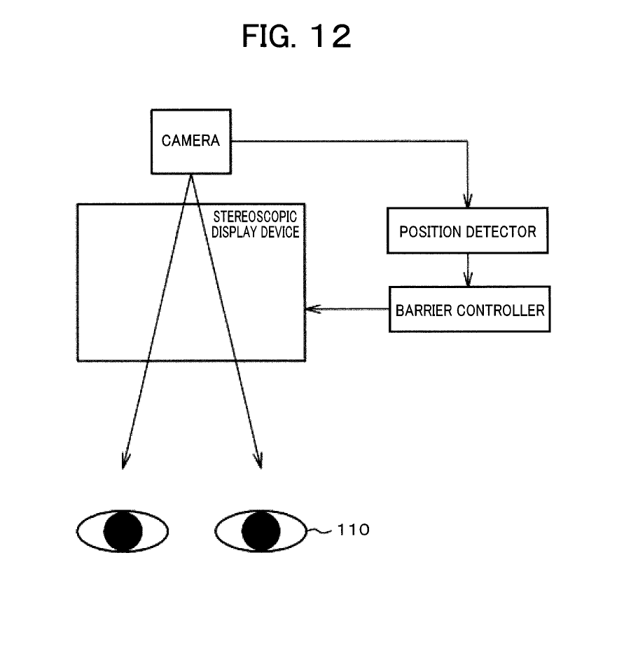

FIG. 12 is a block diagram showing a system for tracking the movement of the line of sight with a camera and feeding the data to the display device. Hereinafter, this system is referred to as the eye tracking system. In FIG. 12, the position of a human eye 110 is measured by a camera. If a photographic camera, such as a cell phone camera, is used as this camera, it is possible to apply this system without using a special dedicated camera.

In FIG. 12, the position of the human eye 110 detected by the camera is input to a position detector, and the signal from the position detector is input to a barrier controller. The barrier controller produces a signal for controlling the position of the barrier pattern on the barrier substrate to input the signal to the three dimensional display device having the parallax barrier panel.

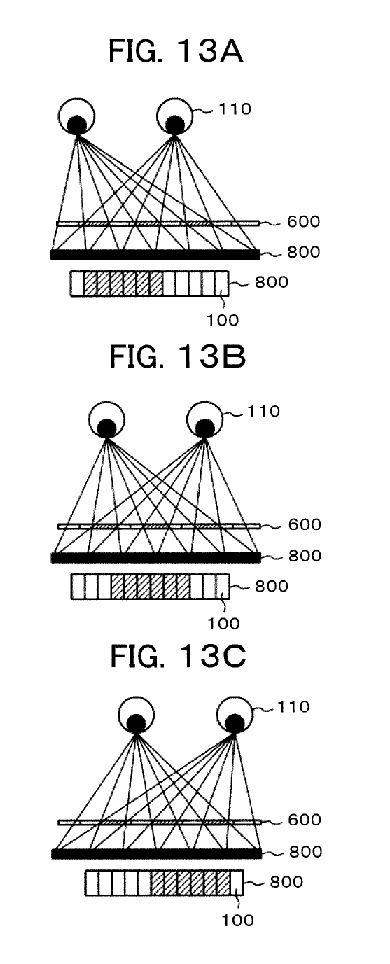

FIGS. 13A to 13C are schematic views showing states in which the barrier pattern 600 is moved in accordance with the movement of the human eye 110 to prevent crosstalk between pixels for a right eye and pixels for a left eye even when the human eye 110 moves. In FIGS. 13A to 13C, the human eye 110 recognizes a pixel pattern 800 through the barrier pattern 600, thereby allowing a human to recognize a three dimensional image. FIGS. 13A to 13C show states in which the human eye 110 is moving from left to right on the drawing sheet, and the barrier pattern 600 is moved from left to right in accordance with the movement of the human eye 110. Thus, crosstalk between pixels for a right eye and pixels for a left eye even can be prevented.

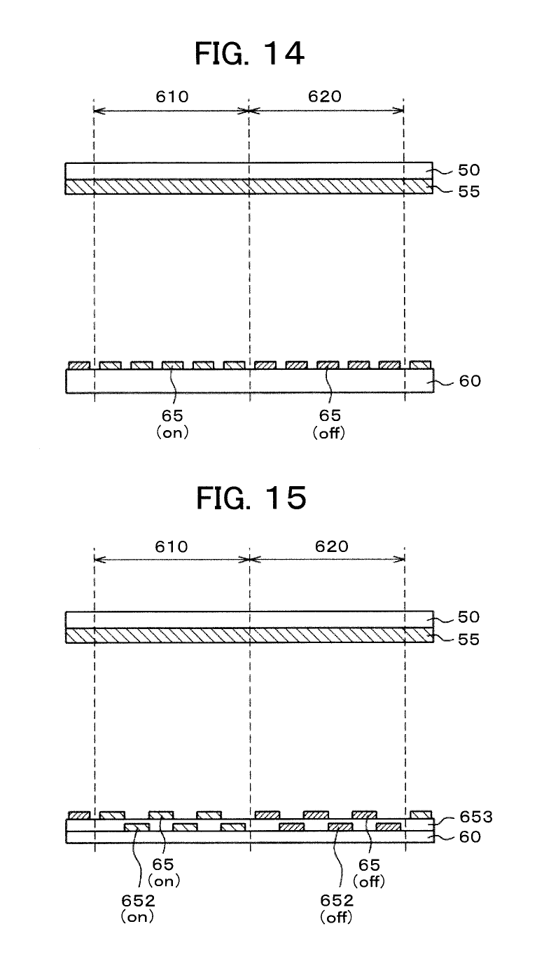

FIG. 14 shows an electrode structure for moving the barrier pattern 600 on the parallax barrier panel. Referring to FIG. 14, the counter electrode 55 is formed flat on the counter substrate 50, in the same manner as the related art. On the other hand, the barrier electrodes 65 on the barrier substrate 60 form a stripe pattern extending in a vertical direction on the drawing sheet. In FIG. 14, five of the barrier electrodes 65 are turned on to thereby form the barrier region 610, and the opening region 620 is formed corresponding to turned-off five of the barrier electrodes 65. The position of the barrier region 610 can be moved by turning off the barrier electrode 65 on one side of the barrier region 610 and turning on the barrier electrode 65 on the other side.

In this manner, the position of the barrier region 610 can be moved by forming the barrier region 610 with the plurality of barrier electrodes 65, thereby allowing more precise feedback with the eye tracking system.

It should be noted that in FIG. 14, the barrier region 610 is formed in a region where the barrier electrodes 65 are in an on state, and the transmission region 620 is formed in a region where the barrier electrodes 65 are in an off state. It should also be noted that the state where the barrier electrodes 65 are in an on state corresponds to the state where a voltage is applied to the barrier electrodes 65. The width of the barrier region 610 or the transmission region 620 corresponds to the width of one pixel, that is, the total width of sub-pixels including a red pixel (R), a green pixel (G), and a blue pixel (B).

FIG. 15 is another example of the case where the barrier region 610 is formed with the plurality of barrier electrodes 65. In the example shown in FIG. 14, because there are gaps between the plurality of divided barrier electrodes 65, leakage of light from the gaps might occur. The leakage of light causes crosstalk between an image for a right eye and an image for a left eye. Referring to FIG. 15, the barrier electrodes 65 are formed in two layers with an insulating film 653 sandwiched therebetween on the barrier substrate 60 so that no gap is generated between the barrier electrodes 65 when viewed from the counter substrate 50. Thus, leakage of light in the barrier region 610 is completely blocked and the occurrence of crosstalk due to the leakage of light can be prevented.

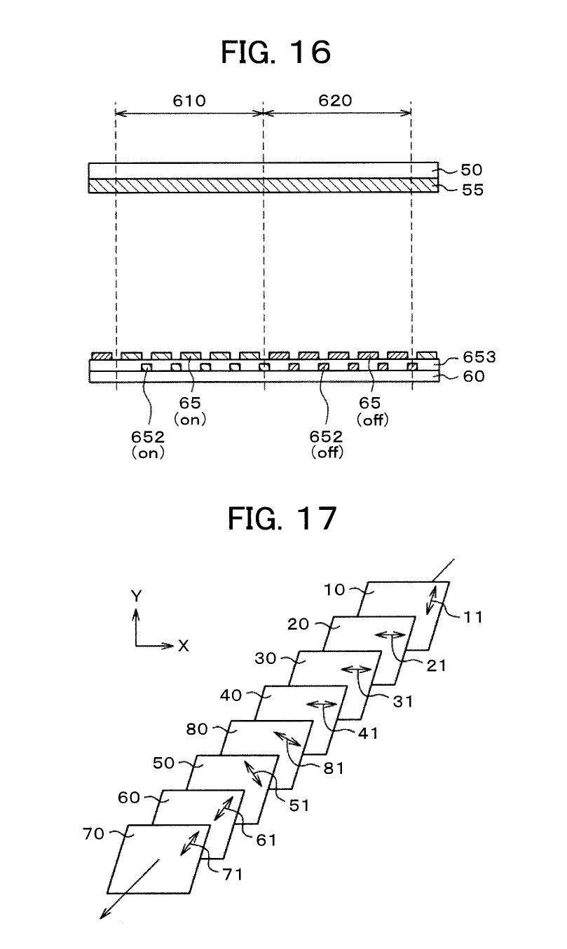

FIG. 16 is yet another example of the case where the barrier region 610 is formed with the plurality of barrier electrodes 65. FIG. 16 differs from FIG. 15 in that the interval between the barrier electrodes 65 on the upper layer is smaller than the width of each of the barrier electrodes 65 and the width of each of barrier electrodes 652 on the lower layer is smaller than the width of each of the barrier electrodes 65 on the upper layer. FIG. 16 is the same as FIG. 15 in that the barrier electrodes 65 are formed in two layers with an insulating film 653 sandwiched therebetween on the barrier substrate 60 so that no gap is generated between the barrier electrodes 65 when viewed from the counter substrate 50. That is, the barrier electrodes 65 on the upper layer and the barrier electrodes 652 on the lower layer do not necessarily have to be equal in width.

In the configuration of the barrier electrodes 65 as shown in FIG. 16, operation is simplified by setting the barrier electrodes 65 and 652 on the upper and lower layers arranged adjacent to each other across the insulating film 653 to the same potential.

As described above, in this embodiment, the alignment axes 51 and 61 of the counter substrate 50 and the barrier substrate 60 constituting the parallax barrier panel are not aligned with the transmission axis 41 of the second polarizing plate 40, leading to a reduction in the transmittance of the parallax barrier panel, an increase in front crosstalk, etc. However, image degradation, such as an increase in crosstalk, caused by the reduction in the viewing angle of the parallax barrier panel when the line of sight moves can be prevented, thereby allowing an improvement in the overall display quality of the three dimensional image display with the parallax barrier system.

As described above, by forming the plurality of divided barrier electrodes 65 and moving the position of the barrier region in accordance with the movement of the line of sight, it is possible to form three dimensional images with reduced crosstalk. Furthermore, by using the eye tracking system, in the parallax barrier, crosstalk is suppressed even when the line of sight is moved, thereby allowing a viewer to recognize excellent three dimensional images.

### Second Embodiment

FIG. 17 is a schematic view of a three dimensional display device of the parallax barrier system according to a second embodiment of the present invention. FIG. 17 differs from FIG. 8 showing the first embodiment in that a λ/2 retardation plate 80 is disposed between the counter substrate 50 of the parallax barrier panel and the second polarizing plate 40. A slow axis 81 of the λ/2 retardation plate 80 is inclined at 22.5 degrees to the horizontal direction, namely the x-axis direction. In the first embodiment shown in FIG. 8, the front transmittance decreases as shown in FIG. 10. On the other hand, in the second embodiment, the polarization direction of the light passing through the second polarizing plate 40 is rotated by using the λ/2 retardation plate 80, thereby allowing an improvement in the transmittance of the parallax barrier panel. The other constitution is the same as those in FIG. 8.

This embodiment can also be applied to any system, whether the pixel electrode has vertical comb teeth or horizontal comb teeth, or whether in the e-mode or in the o-mode. FIG. 18 is a table showing the relationship among the transmission axes 11, 41, and 71 of the first to third polarizing plates 10, 40, and 70 and the alignment axes of the TFT substrate 20, the color filter substrate 30, the counter substrate 50 and the barrier substrate 60 according to the second embodiment. In this embodiment, by using the λ/2 retardation plate 80, it is possible to improve the transmittance of the parallax barrier panel and suppress front crosstalk in the parallax barrier system. It is also possible to improve the viewing angle in the parallax barrier system in the same manner as the first embodiment.

The crosstalk reducing effect of the second embodiment is shown in FIG. 11. In the second embodiment, the front crosstalk is slightly deteriorated as compared with the related art, but improved as compared with the first embodiment. Furthermore, the crosstalk in a direction inclined at 30 degrees with respect to the normal direction to the principal surface of the display device is drastically improved as compared with the related art and also improved as compared with the first embodiment. Thus, the display quality of the three dimensional image display with the parallax barrier system can be improved.

### Third Embodiment

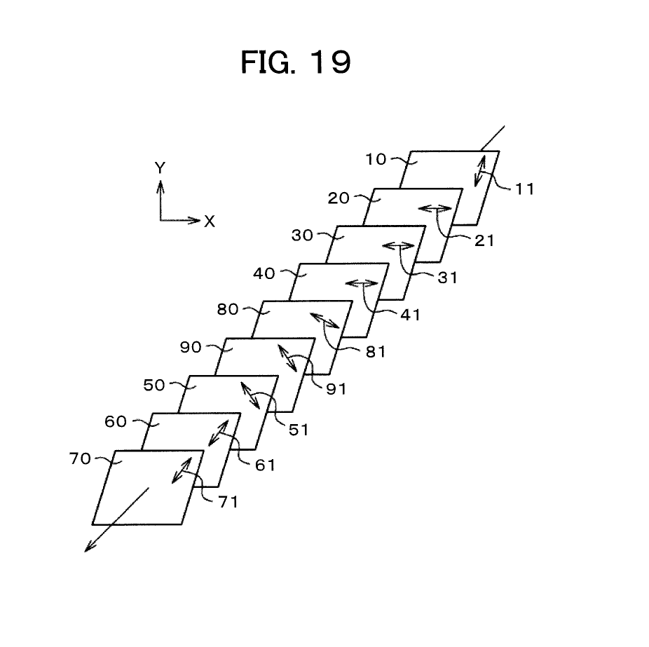

FIG. 19 is a schematic view of a three dimensional display device of the parallax barrier system according to a third embodiment of the present invention. FIG. 19 differs from FIG. 17 showing the second embodiment in that a fourth polarizing plate 90 is disposed between the counter substrate 50 of the parallax barrier panel and the λ/2 retardation plate 80. The other constitution is the same as FIG. 17 showing the second embodiment. In the second embodiment, although the polarization direction of the light passing through the second polarizing plate 40 is rotated by using the λ/2 retardation plate 80 so as to improve the transmittance of the parallax barrier panel, the effects of the λ/2 retardation plate 80 are different for each wavelength of the light. In this regard, looking at the effect for each chromaticity, in some cases a sufficient crosstalk reducing effect cannot be obtained.

In the third embodiment, the fourth polarizing plate 90 having its transmission axis 91 oriented at 45 degrees, the same direction as the alignment axis 51 of the counter substrate 50 of the parallax barrier panel, is disposed at the rear of the λ/2 retardation plate 80, thereby restricting the incident light to the counter substrate 50 and preventing characteristics from varying depending on chromaticity. This embodiment can also be applied to any system, whether the pixel electrode has vertical comb teeth or horizontal comb teeth, or whether in the e-mode or in the o-mode.

FIG. 20 is a table showing the relationship among the transmission axes 11, 41, 71, and 91 of the first to fourth polarizing plates 10, 40, 70, and 90 and the alignment axes 21, 31, 51, and 61 of the TFT substrate 20, the color filter substrate 30, the counter substrate 50 and the barrier substrate 60 according to the third embodiment. In this embodiment, by using the λ/2 retardation plate 80 and the fourth polarizing plate 90, it is possible to improve the transmittance of the parallax barrier panel and suppress front crosstalk in the parallax barrier system. It is also possible to improve the viewing angle in the parallax barrier system in the same manner as the first embodiment.

The crosstalk reducing effect of the third embodiment is shown in FIG. 11. In the third embodiment, the front crosstalk is slightly deteriorated as compared with the related art, but improved as compared with the first and second embodiments. Furthermore, the crosstalk in a direction inclined at 30 degrees with respect to the normal direction to the principal surface of the display device is drastically improved as compared with the related art and also improved as compared with the first and second embodiments. Thus, the display quality of the three dimensional image display with the parallax barrier system can be improved.

### Fourth Embodiment

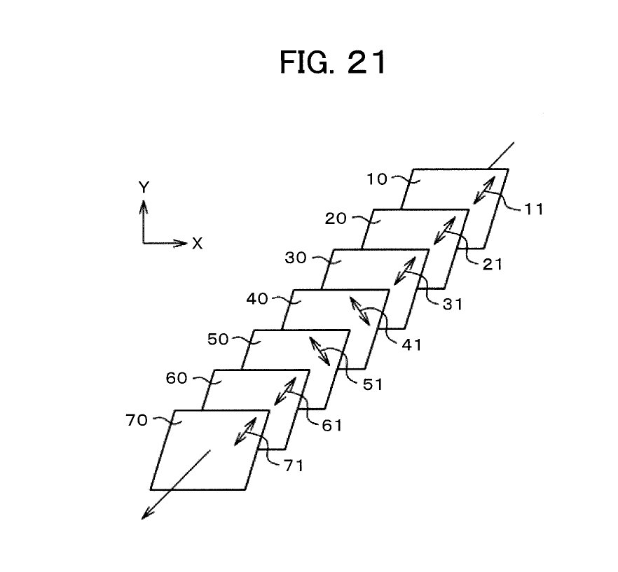

FIG. 21 is a schematic view of a three dimensional display device of the parallax barrier system according to a fourth embodiment of the present invention. FIG. 21 differs from FIG. 8 showing the first embodiment in that the alignment axes 21 and 31 of the TFT substrate 20 and the color filter substrate 30 constituting the IPS-mode liquid crystal display panel are 45 or 135 degrees rather than 0 or 90 degrees. Thus, the reduction in transmittance and the front crosstalk can be reduced even when the λ/2 retardation plate 80 or the fourth polarizing plate 90 is not disposed between the liquid crystal display panel and the parallax barrier panel. Also, the viewing angle in the parallax barrier system can be improved, in the same manner as the first embodiment. However, in the fourth embodiment, the comb teeth or slits of the pixel electrode need to be inclined at about 45 degrees to the horizontal direction.

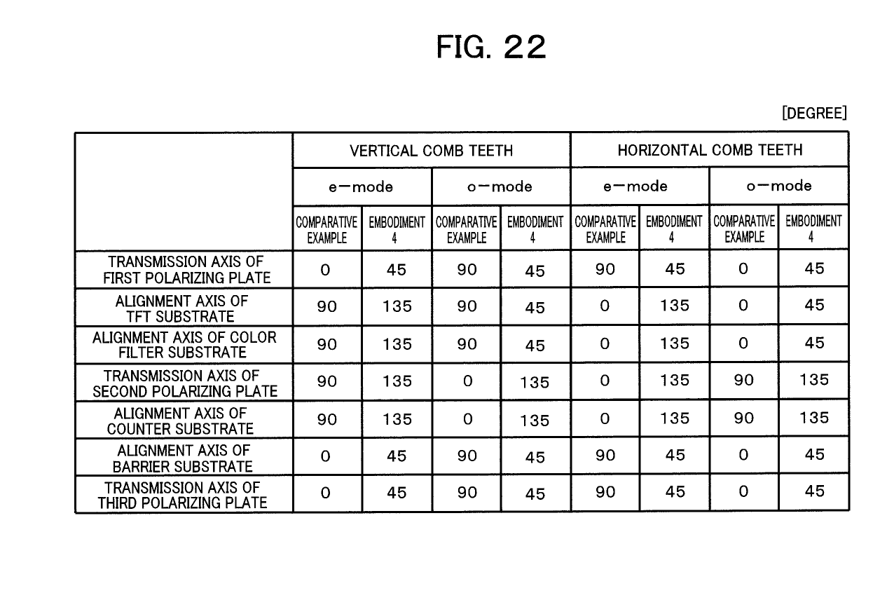

FIG. 22 is a table showing the relationship among the transmission axes 11, 41, and 71 of the first to third polarizing plates 10, 40, and 70 and the alignment axes 21 and 31 of the TFT substrate 20, the color filter substrate 30, and the alignment axes 51 and 61 of the counter substrate 50 and the barrier substrate 60 constituting the parallax barrier panel according to the fourth embodiment. In FIG. 22, the two angles, 45 and 135 degrees are interchangeable. For example, in the case of the vertical comb teeth and the e-mode, the transmission axis 11 of the first polarizing plate 10 is set to 45 degrees and the alignment axis 21 of the TFT substrate 20 is set to 135 degrees. However, the transmission axis 11 of the first polarizing plate 10 may be set to 135 degrees and the alignment axis 21 of the TFT substrate 20 may be set to 45 degrees.

The crosstalk reducing effect of the fourth embodiment is shown in FIG. 11. In the fourth embodiment, the front crosstalk is slightly deteriorated as compared with the related art, but improved as compared with the first and second embodiments. Furthermore, the crosstalk in a direction inclined at 30 degrees with respect to the normal direction to a principal surface of the display device is drastically improved as compared with the related art and also improved as compared with the first and second embodiments.

Referring to FIGS. 9, 18, and 20 of the first to third embodiments, in the case where the pixel electrode has vertical comb teeth, the alignment axis 21 or 31 of the TFT substrate 20 or the color filter substrate 30 constituting the liquid crystal display panel, is set to 90 degrees. However, in an actual product, the alignment axis is shifted by an angle of about ±8° from the 90 degrees in order to clearly define the rotational direction of the liquid crystal molecules 300. Furthermore, although the alignment axis according to the fourth embodiment is set to 45 degrees, if the shape of the pixel electrode corresponds to the single domain, in an actual product, the alignment axis is shifted by an angle of, for example, about ±8° from the 45 degrees in order to clearly define the rotational direction of the liquid crystal molecules 300. This is intended to prevent the occurrence of disclination.

In short, in the tables such as FIGS. 9, 18, and 20, the angles of the alignment axis 21 or 31 of the TFT substrate 20 or the color filter substrate 30, are not necessarily 0, 90, 45, and 135 degrees, but have a margin of error up to roughly ±10°.

In addition, in the above-described first to third embodiments, the case where the pixel electrode has vertical comb teeth as shown in FIG. 3A is described as the single domain, and the case where the pixel electrode has horizontal comb teeth as shown in FIG. 3B is described as the multi-domain. However, FIGS. 3A and 3B are just examples, and the case where the pixel electrode has vertical comb teeth can also be set as the multi-domain by bending the shape of the slits, or the like. Furthermore, even in the case where the pixel electrode has horizontal comb teeth, depending on the design, the pixel may be set as the single domain without bending the shape of the slits. Moreover, the pixel with the multi-domain structure may have other shapes regardless of the shape shown in FIG. 3B.

What is claimed is:

1. A three dimensional display device of a parallax barrier system in which an IPS (In-Plane Switching) mode liquid crystal display panel and a parallax barrier panel, which is a TN (Twisted Nematic) mode liquid crystal panel, are laminated, comprising:
the IPS-mode liquid crystal display panel having a TFT substrate formed with pixel electrodes and a color filter substrate;
the parallax barrier panel having a barrier substrate formed with barrier electrodes and a counter substrate formed with a counter electrode, the barrier electrodes extending in a first direction and being arranged at a first pitch in a second direction, the parallax barrier panel including a barrier region and an opening region, the barrier region being formed by applying a voltage to a first number of adjacent barrier electrodes, the opening region being formed by applying no voltage to the first number of adjacent barrier electrodes adjacent to the barrier region, the barrier region and the opening region being formed at a second pitch, the barrier region being positionally changeable by changing the barrier electrodes for applying the voltage; and
first to third polarizing plates, the first polarizing plate being disposed under the TFT substrate, the second polarizing plate being disposed above the color filter substrate, and the third polarizing plate being disposed above the barrier substrate,
the counter substrate having an alignment axis forming an angle of 45 degrees, plus or minus 10 degrees, with a horizontal direction of a display screen, and
the color filter substrate having an alignment axis forming an angle of 45 degrees, plus or minus 10 degrees, with the alignment axis of the counter substrate.

2. The three dimensional display device according to claim 1, further comprising second barrier electrodes disposed below the barrier electrodes with an insulating film interposed therebetween for filling gaps between the barrier electrodes,
wherein the first number of barrier electrodes and the first number of the second barrier electrodes form the barrier region.

3. The three dimensional display device according to claim 1, further comprising a camera for sensing movement of a human eye,
wherein the barrier region is positionally changed by changing the barrier electrodes for applying the voltage in accordance with the movement of the human eye.

4. The three dimensional display device according to claim 2, further comprising a camera for sensing movement of a human eye,
wherein the barrier region is positionally changed by changing the barrier electrodes and the second barrier electrodes for applying the voltage in accordance with the movement of the human eye.

5. The three dimensional display device according to claim 1, further comprising a λ/2 retardation plate disposed between the second polarizing plate and the counter substrate.

6. The three dimensional display device according to claim 5, further comprising second barrier electrodes disposed below the barrier electrodes with an insulating film interposed therebetween for filling gaps between the barrier electrodes,
wherein the first number of barrier electrodes and the first number of the second barrier electrodes form the barrier region.

7. The three dimensional display device according to claim 5, further comprising a camera for sensing movement of a human eye,
wherein the barrier region is positionally changed by changing the barrier electrodes for applying the voltage in accordance with the movement of the human eye.

8. The three dimensional display device according to claim 6, further comprising a camera for sensing movement of a human eye,
wherein the barrier region is positionally changed by changing the barrier electrodes and the second barrier electrodes for applying the voltage in accordance with the movement of the human eye.

9. The three dimensional display device according to claim 5, further comprising a fourth polarizing plate disposed between the λ/2 retardation plate and the counter electrode.

10. The three dimensional display device according to claim 9, further comprising second barrier electrodes disposed below the barrier electrodes with an insulating film interposed therebetween for filling gaps between the barrier electrodes,
wherein the first number of barrier electrodes and the first number of the second barrier electrodes form the barrier region.

11. The three dimensional display device according to claim 9, further comprising a camera for sensing movement of a human eye,
wherein the barrier region is positionally changed by changing the barrier electrodes for applying the voltage in accordance with the movement of the human eye.

12. The three dimensional display device according to claim 10, further comprising a camera for sensing movement of a human eye,
wherein the barrier region is positionally changed by changing the barrier electrodes and the second barrier electrodes for applying the voltage in accordance with the movement of the human eye.

13. A three dimensional display device of a parallax barrier system in which an IPS (In-Plane Switching) mode liquid crystal display panel and a parallax barrier panel, which is a TN (Twisted Nematic) mode liquid crystal panel, are laminated, comprising:
the IPS-mode liquid crystal display panel having a TFT substrate formed with pixel electrodes and a color filter substrate;
the parallax barrier panel having a barrier substrate formed with barrier electrodes and a counter substrate formed with a counter electrode, the barrier electrodes extending in a first direction and being arranged at a first pitch in a second direction, the parallax barrier panel including a barrier region and an opening region, the barrier region being formed by applying a voltage to a first number of adjacent barrier electrodes, the opening region being formed by applying no voltage to the first number of adjacent barrier electrodes adjacent to the barrier region, the barrier region and the opening region being formed at a second pitch, the barrier region being positionally changeable by changing the barrier electrodes for applying the voltage; and
first to third polarizing plates, the first polarizing plate being disposed under the TFT substrate, the second polarizing plate being disposed above the color filter substrate, and the third polarizing plate being disposed above the barrier substrate,
the counter substrate having an alignment axis forming an angle of 45 degrees, plus or minus 10 degrees, with a horizontal direction of a display screen, and
the color filter substrate having an alignment axis forming an angle of 0 degrees, plus or minus 10 degrees, with the alignment axis of the counter substrate.

14. The three dimensional display device according to claim 13, further comprising second barrier electrodes disposed below the barrier electrodes with an insulating film interposed therebetween for filling gaps between the barrier electrodes,
wherein the first number of barrier electrodes and the first number of the second barrier electrodes form the barrier region.

15. The three dimensional display device according to claim 13, further comprising a camera for sensing movement of a human eye,
wherein the barrier region is positionally changed by changing the barrier electrodes for applying the voltage in accordance with the movement of the human eye.

16. The three dimensional display device according to claim 14, further comprising a camera for sensing movement of a human eye,
wherein the barrier region is positionally changed by changing the barrier electrodes and the second barrier electrodes for applying the voltage in accordance with the movement of the human eye.
